(19) United States
(12) Patent Application Publication
(10) Pub. No.: US 2016/0027219 A1
(43) Pub. Date: Jan. 28, 2016

(54) AUGMENTED REALITY SYSTEMS AND METHODS USED TO IDENTIFY TOYS AND TRIGGER VIDEO AND GRAPHICS

(71) Applicants: Jeffrey Louis NUZZI, Pasadena, CA (US); RUBICON GROUP HOLDING LIMITED, Road Town, Tortolla (VG)

(72) Inventor: Jeffrey Louis NUZZI, Pasadena, CA (US)

(73) Assignee: Rubicon Group Holding Limited, Toetola (VG)

(21) Appl. No.: 14/775,727

(22) PCT Filed: Mar. 17, 2014
(86) PCT No.: PCT/US14/30323

§ 371 Date: Sep. 14, 2015

Related U.S. Application Data
(60) Provisional application No. 61/798,069, filed on Mar. 15, 2013.

(51) Int. Cl. G06T 19/00

(52) U.S. Cl. CPC G06T 19/006

(57) ABSTRACT

An augmented reality system, used to identify toys and trigger video and graphics, includes an input device, one or more toy markers, a computer database, and a controller. Both the input device and the database are coupled to a network. The input device is configured to capture images and playback video, while the toy target marker is configured for image capture and video playback. The controller is coupled to the input device for manipulation of video and graphics such that when one or more toys contained in a real world environment, are manipulated, the toys are augmented, using computer-generated sensory input and a manipulated toy image is created.

### CROSS-REFERENCE TO RELATED APPLICATIONS

This application is a national stage application (under 35 USC §371) of PCT/US2014/030323, filed Mar. 17, 2014, which claims benefit of United States application No. 61/798,069, filed Mar. 15, 2013, the entire disclosure of which is hereby incorporated herein by reference.

### FIELD OF THE INVENTION

The present disclosure relates to augmented reality systems and methods used to identify toys and trigger video and graphics.

### BACKGROUND OF THE INVENTION

Children of today are immersed in technology and the use of interne connected devices such as phones and tablets. Many of these devices are provided with video cameras that interact with applications (apps) that may be used for a child's enjoyment. One type of technology that is particularly suited to provide amusement for children and the young at heart is augmented reality.

Augmented reality takes real world objects and augments those objects through the use of computer-generated sensory input, e.g. video. Currently available systems, however, which incorporate augmented reality, have primarily focused upon enhancing shopping, health science, gaming, and navigation. While useful for their intended purpose, there is still a need for new augmented reality systems and particularly systems that capture real world images of objects such as toys used by children during play. The present invention fulfills this need and provides further related advantages, as described below.

### BRIEF DESCRIPTION OF THE SEVERAL VIEWS OF THE DRAWINGS

The following detailed description, will be better understood when read in conjunction with the appended drawings. For purposes of illustrations, there are shown in the drawings embodiments which are presently preferred. It should be understood, however, that the invention is not limited to the precise arrangements and instrumentalities shown. The drawings described herein are for illustrative purposes and are not intended to limit the scope of the present disclosure. Like element numerals may be used to indicate like elements appearing in one or more of the figures.

In the drawings:

FIG. 1 shows an augmented reality system used to identify toys and trigger video and graphics.

FIG. 2 is a flowchart, showing a method of using an augmented reality system used to identify toys and trigger video and graphics.

### DETAILED DESCRIPTION OF THE INVENTION

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

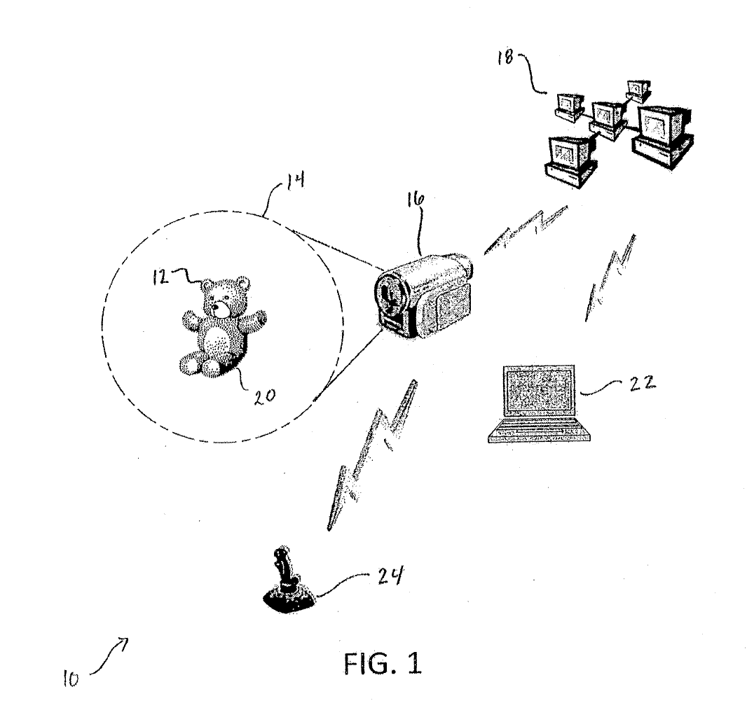

Turning in detail to the drawings, FIG. 1 shows an augmented reality system 10 used to identify toys and trigger video and graphics. The system 10 takes one or more toys 12 contained in a real world environment 14 and augments those toys using computer-generated sensory input such as video and graphics to create a manipulated toy image. By using the systems described herein a user, e.g. a child, is therefore able to manipulate a real world toy in an interactive manner.

This system configuration includes an input device 16 connected to a network 18, a toy target marker 20, a computer database 22 and a controller 24. The input device 16 is any type of device configured for image capture and video playback that is connected to a network. In some system configurations, the input device is contained within a cellular device (e.g. phone or tablet) having a camera. Such devices, therefore, include a processor, displays, sensors, augmented reality client, etc. The system also includes one or more toys 12 contained within the real world environment 14. The term “toy” as used herein, however, is not limited to figurines and stuffed animals. Rather, the term includes other items that may be used for play purposes including cards, board games, collectibles, and other items used for play in real world environments. The system also includes a computer database 22 such as a back-end SQL database that is configured to detect toy type and generate video and graphics of the toy 12. The system 10 may also include one or more controllers 20 for use by a user. The controller is either coupled to or built into the input device 16 for manipulation of video and graphics. The type of manipulation may vary, however, depending upon toy type.

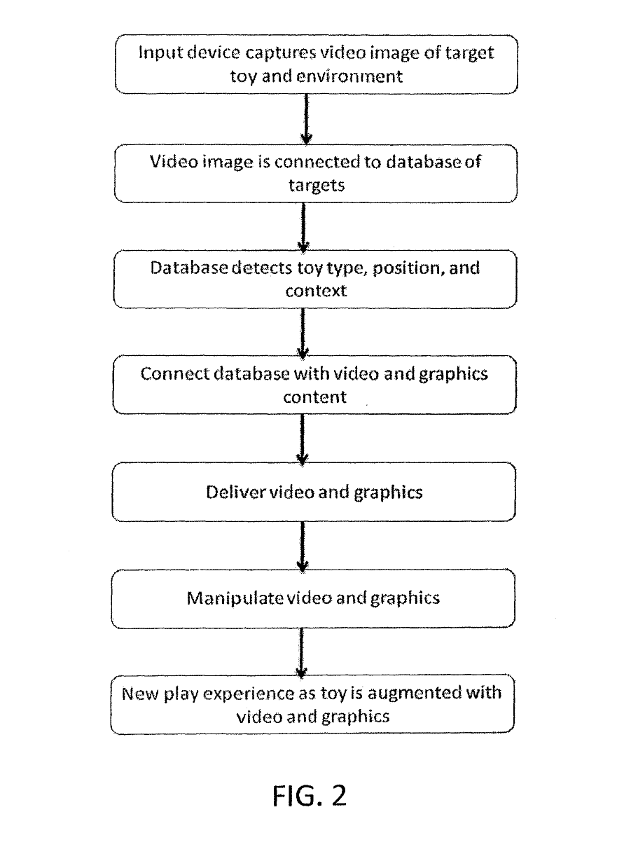

FIG. 2 shows a method 100 of using an augmented reality system used to identify toys and trigger video and graphics. The method includes the steps of capturing toy video images of a toy 110 by an input device, connecting the captured toy video images to a database of targets 120, detecting toy type and toy position 130, connecting to a database having video and graphics content 140, delivering the video and graphics content 150, manipulating the video and graphics content 160, and generating manipulated video and graphics of the toy to integrate with augmented reality imagery 170.

Accordingly, augmented reality systems and methods used to identify toys and trigger video and graphics are disclosed. While embodiments of this invention have been shown and described, it will be apparent to those skilled in the art that many more modifications are possible without departing from the inventive concepts herein. The invention, therefore, is not to be restricted except in the spirit of the following claims.

1. An augmented reality system use to identify toys and trigger video and graphics, the system comprising:
an input device coupled to a network, wherein the input device is configured to capture images and playback video;
at least one toy a toy target marker for image capture and video playback, a computer database connected to the network; and
a controller coupled to the input device for manipulation of video and graphics.

2. A method of using the augmented reality system, as claimed in claim 1, to identify toys and trigger video and graphics, the method comprising:
capturing video images of a toy by the input device;
connecting the captured toy video images to a database of targets;
detecting toy type and toy position from the captured toy video images, connecting to a computer database having video and graphics content, delivering the video and graphics content;
manipulating the video and graphics content, and generating manipulated video and graphics of the captured toy video images to integrate with augmented reality imagery.
